(19) United States
(12) Patent Application Publication
(10) Pub. No.: US 2024/0118947 A1
(43) Pub. Date: Apr. 11, 2024

(54) METHOD, DEVICE AND MEDIUM FOR SUBSCRIBING APPLICATIONS

(71) Applicant: BOE TECHNOLOGY GROUP CO., LTD., Beijing (CN)

(72) Inventor: Qian ZHANG, Beijing (CN)

(73) Assignee: BOE TECHNOLOGY GROUP CO., LTD., Beijing (CN)

(21) Appl. No.: 18/273,294

(22) PCT Filed: Jan. 21, 2022
(86) PCT No.: PCT/CN2022/073217

§ 371 Date: Jul. 20, 2023

(30) Foreign Application Priority Data
Jan. 26, 2021 (CN) 202110103875.4

(51) Int. Cl. G06F 9/54

(52) U.S. Cl. CPC G06F 9/542

(57) ABSTRACT

A novel method, device and medium for subscribing applications. The method may be performed by a common service entity, and includes: creating a subscribed-to resource associated with a monitored application entity based at least in part on an action resource associated with the monitored application entity; and sending a subscription notification corresponding to the action resource to a notified application entity when a resource attribute of the monitored application entity changes. With this method, a subscription notification of an action resource associated with an Internet of Things (IoT) device can be sent to a notified application entity in time in response to an attribute change of resources of the IoT device, so that a user can decide, independently or by an IoT management platform, whether the relevant action resource continues to be valid or invalid, thereby more conforming to actual operation practices of the user and enhancing IoT experience.

### CROSS-REFERENCE TO RELATED APPLICATION

This application claims priority to China Patent Application No. 202110103875.4 filed on Jan. 26, 2021, contents of which are hereby incorporated by reference in its entirety as a part of this application.

### TECHNICAL FIELD

The present disclosure relates to a field of Internet of Things, and in particular to a novel method, device and medium for subscribing applications.

### BACKGROUND

Internet of Things (IoT) technology is a networked application and service with intelligent interaction of machines as a core, which realizes users' information requirements for monitoring, command and dispatch, data acquisition and measurement by embedding wireless or wired communication modules and application processing logics within IoT devices.

With development of IoT technology, more and more IoT devices (also called entities) have been connected to the IoT. The IoT manages various IoT devices by building an IoT management platform. The IoT management platform generates resources corresponding to an IoT device to represent the IoT device, and controls the IoT device by operating the resources.

Smart home platform is a common IoT management platform, where physical appliances are connected to the smart home platform by wired or wireless ways, and the smart home platform generates virtual appliances (i.e., resources) for the physical appliances. An application terminal accesses the virtual appliances through the smart home platform, thus realizing remote monitoring and control of the appliances.

In addition, the application terminal can create different intelligent scenes through the IoT management platform (such as the smart home platform) and associate IoT devices in these intelligent scenes, so as to realize further control of the IoT devices.

At present, a connection between action resources and subscribed-to resources of the IoT is not close enough, so it is necessary to further improve a process control of the IoT.

### SUMMARY

Aiming at the above problems, the present disclosure provides a novel method, device and medium for subscribing applications. With the novel method for subscribing applications provided by the present disclosure, it is possible to subscribe to a change of an attribute of resources of an IoT device, and send a subscription notification of an action resource associated with the IoT device to a notified application entity when the attribute of the resources changes, so that a user can learn the relevant action resource and whether it is valid or not in time, and can also independently decide whether some related action resources are continuously valid or invalid, thus more conforming to actual operation practices of the user.

According to an embodiment of the present disclosure, there is provided a method for subscription notification performed by a common service entity, comprising: creating a subscribed-to resource associated with a monitored application entity based at least in part on an action resource associated with the monitored application entity; and sending a subscription notification corresponding to the action resource associated with the monitored application entity to a notified application entity when a resource attribute of the monitored application entity changes.

According to an embodiment of the present disclosure, wherein a plurality of action resources associated with a plurality of application entities are created on the common service entity, and the monitored application entity is one of the plurality of application entities.

According to the embodiment of the present disclosure, wherein the creation of the action resource associated with the monitored application entity comprises: creating the action resource associated with the monitored application entity in response to receiving a request to create the action resource.

According to an embodiment of the present disclosure, wherein the subscribed-to resource comprises an event notification criteria attribute, and an event notification criterion for the subscribed-to resource comprises a registration monitoring attribute, wherein creating the subscribed-to resource associated with the monitored application entity further comprises: adding an identifier of the monitored application entity to a subscription monitoring list corresponding to the registered monitoring attribute.

According to an embodiment of the present disclosure, wherein creating the subscribed-to resource associated with the monitored application entity comprises: in response to receiving a request to create a subscribed-to resource for the monitored application entity, creating the subscribed-to resource associated with resources of the monitored application entity, and adding the identifier of the monitored application entity to the subscription monitoring list.

According to an embodiment of the present disclosure, wherein after the action resource is created, a value of an activation status attribute of the action resource is set to enable monitoring of the action resource.

According to an embodiment of the present disclosure, wherein after sending the subscription notification corresponding to the action resource associated with the monitored application entity to the notified application entity, the method further comprises: setting a value of an activation status attribute of the action resource to disable monitoring of the action resource in response to receiving an indication that the action resource of the monitored application entity is invalid.

According to an embodiment of the present disclosure, wherein determination that the resource attribute of the monitored application entity is changed comprises: receiving a re-registration request of the monitored application entity; comparing a resource attribute of the re-registered monitored application entity with the resource attribute of the monitored application entity before re-registration, and determining whether the resource attribute of the monitored application entity is changed.

According to an embodiment of the present disclosure, wherein determination that the resource attribute of the monitored application entity is changed further comprises: determining to change the resource attribute of the monitored application entity in response to receiving a request to change the resource attribute of the monitored application entity.

According to an embodiment of the present disclosure, wherein the action resource associated with the monitored application entity is created after the monitored application entity completes initial registration.

According to an embodiment of the present disclosure, wherein the subscription notification is used for at least one of: notification on invalidation of a current action resource of the monitored application entity, notification on an action resource list associated with the monitored application entity, and notification on revalidation of the action resource of the monitored application entity.

According to an embodiment of the present disclosure, there is provided a method performed by a terminal for Internet of Things (IoT), comprising: displaying an interface for setting actions of an IoT device, wherein the interface comprises a setting key for setting actions of the IoT device; displaying an enabling key for enabling monitoring of an attribute change of the IoT device in response to the setting key being triggered; subscribing to a subscription notification corresponding to the attribute change of the IoT device in response to the enabling key being triggered, wherein the attribute change of the IoT device causes an abnormal action of the IoT device.

According to an embodiment of the present disclosure, wherein before displaying the interface for setting actions of the IoT device, the method comprises: displaying an action creation interface for creating an action associated with the IoT device, wherein the action creation interface comprises at least one of: a selection box for setting content of the action, a selection box for setting a valid condition of the action, and a selection box for setting attributes of the IoT device associated with the action.

According to an embodiment of the present disclosure, wherein before displaying the interface for creating an action associated with the IoT device, the method comprises: displaying a registration interface for registering the IoT device, wherein the registration interface comprises a key for initiating registration of the IoT device.

According to an embodiment of the present disclosure, wherein the subscription notification is triggered by the attribute change of the IoT device caused by re-registration of the IoT device.

According to an embodiment of the present disclosure, wherein the subscription notification is used for at least one of: notification on invalidation of a current action resource of the IoT device, notification on an action resource list associated with the IoT device, and notification on revalidation of the action resource of the IoT device.

According to an embodiment of the present disclosure, there is provided a method performed by an IoT system, the IoT system comprising a common service entity, a monitored application entity and a notified application entity, the method comprising: sending, by the monitored application entity, a registration request to the common service entity; receiving, by the common service entity, the registration request of the monitored application entity, and sending a registration success response to the monitored application entity; sending, by the notified application entity, a registration request to the common service entity; receiving, by the common service entity, the registration request of the notified application entity, and sending a registration success response to the notified application entity; sending, by the notified application entity, a request for creating an action resource to the common service entity, the action resource being associated with the monitored application entity; receiving, by the common service entity, the request for creating an action resource sent by the notified application entity, and sending a creation success response to the notified application entity; creating, by the common service entity, a subscribed-to resource associated with the monitored application entity based at least in part on the action resource associated with the monitored application entity; and sending, by the common service entity, a subscription notification corresponding to the action resource associated with the monitored application entity to the notified application entity when a resource attribute of the monitored application entity changes.

According to an embodiment of the present disclosure, there is provided an apparatus for performing subscription notification, comprising: a subscribed-to resource creation module configured to create a subscribed-to resource associated with a monitored application entity based at least in part on an action resource associated with the monitored application entity; and a notification module configured to send a subscription notification corresponding to the action resource associated with the monitored application entity to a notified application entity when a resource attribute of the monitored application entity changes.

According to an embodiment of the present disclosure, wherein a plurality of action resources associated with a plurality of application entities are created on the common service entity, and the monitored application entity is one of the plurality of application entities.

According to an embodiment of the present disclosure, wherein the creation of the action resource associated with the monitored application entity comprises: creating the action resource associated with the monitored application entity in response to receiving a request to create the action resource.

According to an embodiment of the present disclosure, wherein the subscribed-to resource comprises an event notification criteria attribute, and an event notification criterion for the subscribed-to resource comprises a registration monitoring attribute, wherein creating the subscribed-to resource associated with the monitored application entity further comprises: adding an identifier of the monitored application entity to a subscription monitoring list corresponding to the registered monitoring attribute.

According to an embodiment of the present disclosure, wherein the subscribed-to resource creation module comprises: in response to receiving a request to create a subscribed-to resource for the monitored application entity, creating the subscribed-to resource associated with resources of the monitored application entity, and adding the identifier of the monitored application entity to the subscription monitoring list.

According to an embodiment of the present disclosure, wherein after the action resource is created, a value of an activation status attribute of the action resource is set to enable monitoring of the action resource.

According to an embodiment of the present disclosure, wherein after sending the subscription notification corresponding to the action resource associated with the monitored application entity to the notified application entity, it further comprises: setting a value of an activation status attribute of the action resource to disable monitoring of the action resource in response to receiving an indication that the action resource of the monitored application entity is invalid.

According to an embodiment of the present disclosure, wherein determination that the resource attribute of the monitored application entity is changed comprises: receiving a re-registration request of the monitored application entity; comparing a resource attribute of the re-registered monitored application entity with the resource attribute of the monitored application entity before re-registration, and determining whether the resource attribute of the monitored application entity is changed.

According to an embodiment of the present disclosure, wherein determination that the resource attribute of the monitored application entity is changed further comprises: determining to change the resource attribute of the monitored application entity in response to receiving a request to change the resource attribute of the monitored application entity. The action resource associated with the monitored application entity is created after the monitored application entity completes initial registration.

According to an embodiment of the present disclosure, wherein the subscription notification is used for at least one of: notification on invalidation of a current action resource of the monitored application entity, notification on an action resource list associated with the monitored application entity, and notification on revalidation of the action resource of the monitored application entity.

According to an embodiment of the present disclosure, there is provided a terminal for Internet of Things (IoT), comprising: an action setting display module configured to display an interface for setting actions of an IoT device, wherein the interface comprises a setting key for setting actions of the IoT device; an attribute change display module configured to display an enabling key for enabling monitoring of an attribute change of the IoT device in response to the setting key being triggered; a subscription notification module configured to subscribe to a subscription notification corresponding to the attribute change of the IoT device in response to the enabling key being triggered, wherein the attribute change of the IoT device causes an abnormal action of the IoT device.

According to an embodiment of the present disclosure, wherein before displaying the interface for setting actions of the IoT device, it comprises: displaying an action creation interface for creating an action associated with the IoT device, wherein the action creation interface comprises at least one of: a selection box for setting content of the action, a selection box for setting a valid condition of the action, and a selection box for setting attributes of the IoT device associated with the action.

According to an embodiment of the present disclosure, wherein before displaying the interface for creating an action associated with the IoT device, it comprises: displaying a registration interface for registering the IoT device, wherein the registration interface comprises a key for initiating registration of the IoT device.

According to an embodiment of the present disclosure, wherein the subscription notification is triggered by the attribute change of the IoT device caused by re-registration of the IoT device.

According to an embodiment of the present disclosure, wherein the subscription notification is used for at least one of: notification on invalidation of a current action resource of the IoT device, notification on an action resource list associated with the IoT device, and notification on revalidation of the action resource of the IoT device.

According to an embodiment of the present disclosure, there is provided an electronic device for performing subscription notification, comprising: a processor; a memory storing computer instructions which, when executed by the processor, implement the method described above.

According to an embodiment of the present disclosure, there is provided a computer-readable storage medium having stored thereon computer instructions which, when executed by a processor, implement the method described above.

The embodiments of the present disclosure provide a novel method, device and medium for subscribing applications. Since a subscription notification of an action resource associated with an IoT device can be sent to a notified application entity in time in response to an attribute change of resources of the IoT device, a user can learn the relevant action resource in time and decide, independently or by an IoT management platform, whether the relevant action resource continues to be valid or invalid, thereby more conforming to actual operation practices of the user and enhancing IoT experience of the user.

### BRIEF DESCRIPTION OF DRAWINGS

Accompanying drawings required in description of the embodiments will be briefly described below to illustrate technical solutions of the embodiments of the present disclosure more clearly. It is obvious that the drawings in the following description are merely some of the embodiments of the present disclosure, and other drawings may be obtained based on these drawings for a person of ordinary skill in the art without creative efforts. The following drawings are not deliberately drawn in scale to actual size, with emphasis on showing a gist of the present disclosure.

FIG. 1A shows a schematic architecture diagram of IoT according to an embodiment of the present disclosure;

FIG. 1B shows a schematic diagram of connections between various devices according to an embodiment of the present disclosure;

FIG. 1C shows an interface diagram of ASN-AE according to an embodiment of the present disclosure;

FIG. 1D shows a schematic diagram of a temperature sensor before and after moving according to an embodiment of the present disclosure;

FIG. 2 shows a flowchart of a method for subscription notification performed by an application entity in an application service node according to an embodiment of the present disclosure;

FIG. 3 shows a flowchart of a method for subscription notification performed by a common service entity according to an embodiment of the present disclosure;

FIG. 4 shows a flowchart of an application entity (AE) or an application program (APP) or a Node registering with a Common Service Entity (CSE).

FIG. 5A shows a flowchart of a method performed by a terminal for IoT according to an embodiment of the present disclosure;

FIG. 5B shows a schematic diagram of an interface for action setting according to an embodiment of the present disclosure;

FIG. 5C shows a schematic diagram of an attribute change monitoring interface according to an embodiment of the present disclosure;

FIG. 6 shows an interaction diagram between a common service entity and an application entity according to an embodiment of the present disclosure;

FIG. 7 shows a structural diagram of an electronic device 700 according to an embodiment of the present disclosure.

### DETAILED DESCRIPTION

In order to make objects, technical solutions and advantages of the present disclosure more obvious, exemplary embodiments according to the present disclosure will be described in detail below with reference to the accompanying drawings. Obviously, the described embodiments are only part of the embodiments of the present disclosure, not all of them. It should be understood that the present disclosure is not limited by the exemplary embodiments described herein.

In this specification and accompanying drawing, steps and element which are basically the same or similar are denoted by the same or similar reference numerals, and repeated description of these steps and elements will be omitted. Meanwhile, in the description of the present disclosure, the terms “first” and “second” and so on are only used to distinguish descriptions, and should not be understood as indicating or implying relative importance or order.

With development of information technology, especially Internet technology, an Internet of Things (IoT) technology used to realize informatization, remote management control and intelligent network is gradually maturing. IoT connects sensors, controllers, machines, people and things together in a new way by using communication technologies such as local network or Internet, forming a connection between people and things, things and things. IoT is an extension of the Internet, which includes the Internet and all resources on the Internet, and is compatible with all applications of the Internet. With application of the IoT technology in various fields, various new application fields such as smart home, smart transportation, and smart health have emerged.

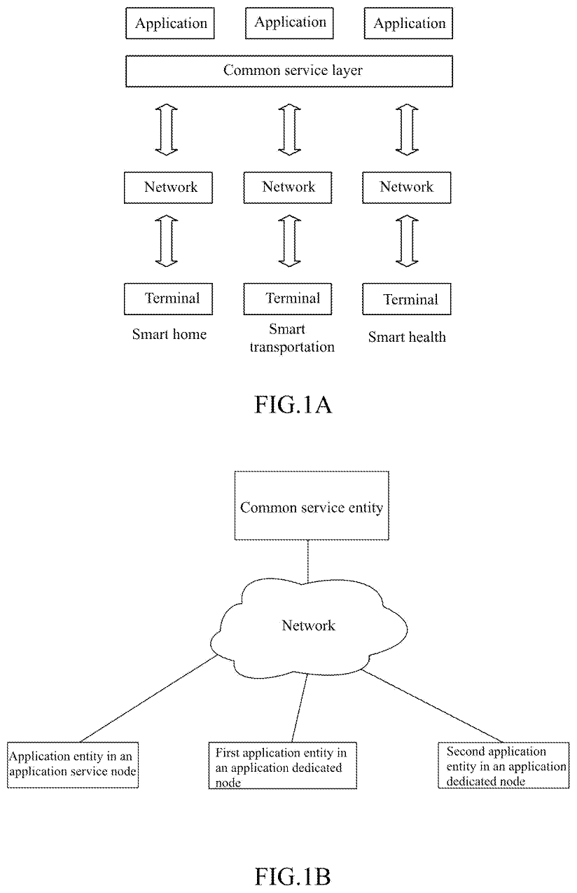

FIG. 1A shows a schematic architecture diagram of IoT according to an embodiment of the present disclosure. FIG. 1B shows a schematic diagram of connections between various devices according to an embodiment of the present disclosure. FIG. 1C shows an interface diagram of ASN-AE according to an embodiment of the present disclosure. FIG. 1D shows a schematic diagram of a temperature sensor before and after moving according to an embodiment of the present disclosure.

FIG. 1A discloses the schematic architecture diagram of IoT in an embodiment of the present disclosure. As shown in FIG. 1A, client devices of various terminals access to a network and access to a common service layer through the network, in which the common service layer supports various applications, thus forming a terminal+network+application architecture. For example, in the field of smart home, various appliances can access a general service platform by Local Area Network (LAN), and such LAN access can be wireless or wired. Optionally, said local area network may be a Personal Area Network (PAN). For example, taking Wireless Personal Area Network (WPAN) as an example, various technologies such as Bluetooth, IrDA, Home RF, ZigBee, or UWB (Ultra-Wideband Radio) may be adopted to realize access.

As mentioned above, after an IoT entity (e.g., a software module in an IoT terminal device or node device) transmits data or information to the general service entity, the data or information may be stored as a separate resource. In addition, the IoT entity may send a request to the common service entity to update resources stored on the common service entity corresponding to the IoT entity, so as to reflect a status of a device on which the IoT entity is operating. This update may be real-time, or periodic, or triggered by a certain condition. Therefore, other IoT entities communicating with the common service entity may learn the status of the device corresponding to the IoT entity by accessing the updated resources; or, other IoT entities communicating with the common service entity may operate the updated resources. It should be noted that the resources referred to herein include resources of various entities (e.g., which may be embodied as software modules in IoT devices, such as AE, CSE and the like). An entity may represent a software module of a communication device, while a common service entity may represent a software module of a service platform, which may be local or remote. Optionally, operating on the updated resource includes, for example, acquiring information of the updated resources, deleting the information of the updated resources, notifying a third party of the information of the updated resources, or operating on other resources based on the information of the updated resources.

In this disclosure, described entities such as an application entity AE, a general service entity CSE, and data, can all be represented by resources. Specifically, a resource may include an attribute and child resources, where the attribute is used to store information related to the resource (e.g., an identifier of the resource, a physical location of an AE corresponding to the resource, status information of the resource, etc.), the child resources are next-level resources of the resource, and the resource includes indexes pointing to the next-level resources.

The application entity AE may include an application entity ASN-AE in an application service node and an application entity ADN-AE in an application dedicated node. The application entity ADN-AE may be a temperature sensor, a humidity sensor, an air purifier, a smart light bulb and the like. The application entity ASN-AE may be a television, a smart appliance (e.g., a smart refrigerator, a smart microwave oven, etc.), a charging car, a desktop computer, a notebook, a smart phone, a tablet, a music player (e.g., an mp3 players, etc.) and other terminal including a processor and a memory (e.g., a mobile terminal, a smart terminal). The application entity ASN-AE may be installed with IoT-related applications to set operation of the application entity ADN-AE through the general service entity CSE. The application entity ASN-AE may send a request to the general service entity CSE to create a subscription to a related application entity ADN-AE.

Referring to FIG. 1B, a general service entity CSE, an application entity ASN-AE (e.g., a mobile phone terminal) in an application service node, a first application entity in an application dedicated node, and a second application entity in the application dedicated node may be connected via a network. The above devices may communicate with each other directly or indirectly, for example, sending and receiving data and/or signals from each other via the network.

The network may be IoT based on the Internet and/or telecommunication network, and it may be either a wired network or a wireless network, for example, may be an electronic network such as a Local Area Network (LAN), a Metropolitan Area Network (MAN), a Wide Area Network (WAN), a cellular data communication network and the like that can realize the function of information exchange.

In some embodiments, the application entity ADN-AE may be a small IoT device such as a thermometer, an air conditioner, a fan, a lamp and the like. After these ADN-AEs are registered with the CSE, the CSE may create thereon corresponding resources. The CSE controls these ADN-AEs by operating on the corresponding resources.

In some embodiments, an operator operates in the ASN-AE (e.g., editing an intelligent scene) to send a request to the CSE to create the intelligent scene (e.g., a request to create a process management resource, a request to create an action resource, a request to create a status resource, etc.), so that each ADN-AE can be linked.

For example, in a smart home scene involved in FIG. 1C, various IoT devices may be linked with each other. The ASN-AE may set an intelligent scene as shown in FIG. 1C to control the IoT devices, which include a temperature sensor, an air-conditioning device, and a fan device. The temperature sensor, the air-conditioning device and the fan device are all placed in a living room. For example, such a smart home scene may be set: when the temperature sensor detects that the ambient temperature is greater than 31 degrees Celsius, turn on the air conditioner, adjust the fan to a first gear of natural wind and turn on the head swing. Then, when the temperature sensor detects that the ambient temperature in the living room is greater than 31 degrees Celsius, the air conditioner in the living room will be turned on, and the fan will be adjusted to the first gear of natural wind and the head swing will be turned on, so that the ambient temperature in the living room will be reduced to meet the user's cooling purpose.

In such a scene, as shown in FIG. 1D, the user moves the temperature sensor to a balcony, unchecks a location “living room” of the temperature sensor and checks “balcony” via the ASN-AE (such as a terminal device (e.g. a mobile phone APP)), so as to complete a change of location information in a resource attribute of the temperature sensor. However, at this time, the ASN-AE will not receive any subscription notice to inform the user of the possible corresponding change of the previously set smart scene, resulting in the intelligent scene actually becoming “turn on the air conditioner in the living room when the balcony temperature is higher than 31 degrees Celsius”, which is inconsistent with the original intention of the intelligent home scene set by the user, does not conform to actual operation practices of the user, and brings a bad experience to the user.

Aiming at the above problems, the present disclosure provides a novel method for subscribing applications. With the novel method for subscribing applications provided by the present disclosure, it is possible to subscribe to a change of an attribute of resources of an IoT device, and send a subscription notification of an action resource associated with the IoT device to a notified application entity when the attribute of the resources changes, so that a user can learn the relevant action resource and whether it is valid or not in time, and can also independently decide whether some related action resources are continuously valid or invalid, thus more conforming to actual operation practices of the user. In particular, the novel method for subscribing applications may be divided into a method for subscription notification performed by a Common Service Entity (CSE), a method for subscription notification performed by an application entity in an application service node (a CSE which residues in the application service node (ASN-AE), and a method performed by a terminal for IoT. The above methods will be described in detail below.

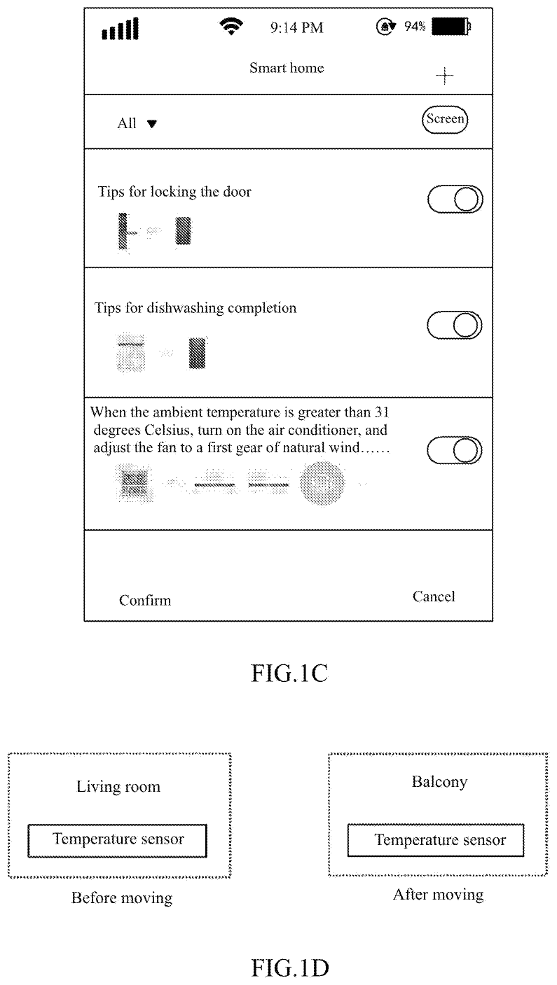

FIG. 2 shows a flowchart of a method for subscription notification performed by an application entity in an application service node according to an embodiment of the present disclosure.

Referring to FIG. 2, in S210, the ASN-AE may send a request to create an action resource, where the action resource may be associated with a monitored application entity (e.g., ADN-AE), and a resource attribute of the monitored application entity is monitored for subscription notification.

As an example, the monitored application entity may include a temperature sensor, an air-conditioning device, an air purification device, a desk lamp device and a door or window sensor.

As an example, the ASN-AE may be an application in a mobile phone.

As an example, the ASN-AE may send a request to the CSE to create an action resource of “Turn on the air conditioner in the living room when the temperature sensor detects that the ambient temperature in the living room is greater than 31 degrees Celsius”, where a resource attribute of the temperature sensor is monitored for subscription notification.

At S220, the ASN-AE may receive a subscription notification corresponding to the action resource associated with the monitored application entity.

According to an embodiment of the present disclosure, not only the above ASN-AE can receive the subscription notification, but also the common service entity CSE can receive the subscription notification. Herein, as an example only, the above ASN-AE receiving the subscription notification is used to describe the relevant schemes.

As an example, the monitored application entity may be a temperature sensor. The ASN-AE may receive a subscription notification corresponding to an action resource associated with the temperature sensor. In particular, it is assumed that the following action resources are set for the temperature sensor:

Action resource 1: “Turn on the air-conditioning device in the living room when the temperature sensor detects that the ambient temperature in the living room is greater than 31 degrees Celsius”;

Action resource 2: “Open the window device in the living room when the temperature sensor detects that the ambient temperature in the living room is greater than 31 degrees Celsius”;

Action resource 3: “Close the windows in the living room when the temperature sensor detects that the ambient temperature in the living room is less than 15 degrees Celsius”.

Then, the ASN-AE may receive a subscribed-to resource corresponding to at least one of the above-mentioned action resources 1 to 3.

According to an embodiment of the present disclosure, the subscription notification may include at least one of: a notification on invalidation of a current action resource of the monitored application entity, a notification on an action resource list associated with the monitored application entity, and a notification on revalidation of the action resource of the monitored application entity.

As an example, when the temperature sensor is moved from the living room to the bedroom, the ASN-AE may receive a notification that the current action resource 1 of the temperature sensor is invalid.

As an example, when the temperature sensor is moved from the living room to the bedroom, the ASN-AE may receive a notification of a list of the action resources 2 to 3 associated with the temperature sensor. Optionally, in said notification, a key may be set at a location corresponding to an action resource for the user to select to determine whether the corresponding action resource continues to be valid or invalid.

As an example, when the temperature sensor is moved from the living room to the bedroom and then the temperature sensor is moved from the guest bedroom to the living room again, the ASN-AE may receive a notification that the action resource 3 of the temperature sensor is valid again.

According to an embodiment of the present disclosure, after sending the request for creating the action resource, it may further include: sending a request for creating a subscribed-to resource, and an event notification criteria condition for the subscribed-to resource includes an identifier of an application entity to be monitored.

As an example, the ASN-AE may send a request to the CSE to create a subscribed-to resource, in which an application entity to be monitored, such as a temperature sensor, is indicated.

As an example, the event notification criteria (eventNotificationCriteria) condition for the subscribed-to resource may include the identifier (e.g., AE-ID-Stem) of the monitored application entity (e.g., the temperature sensor).

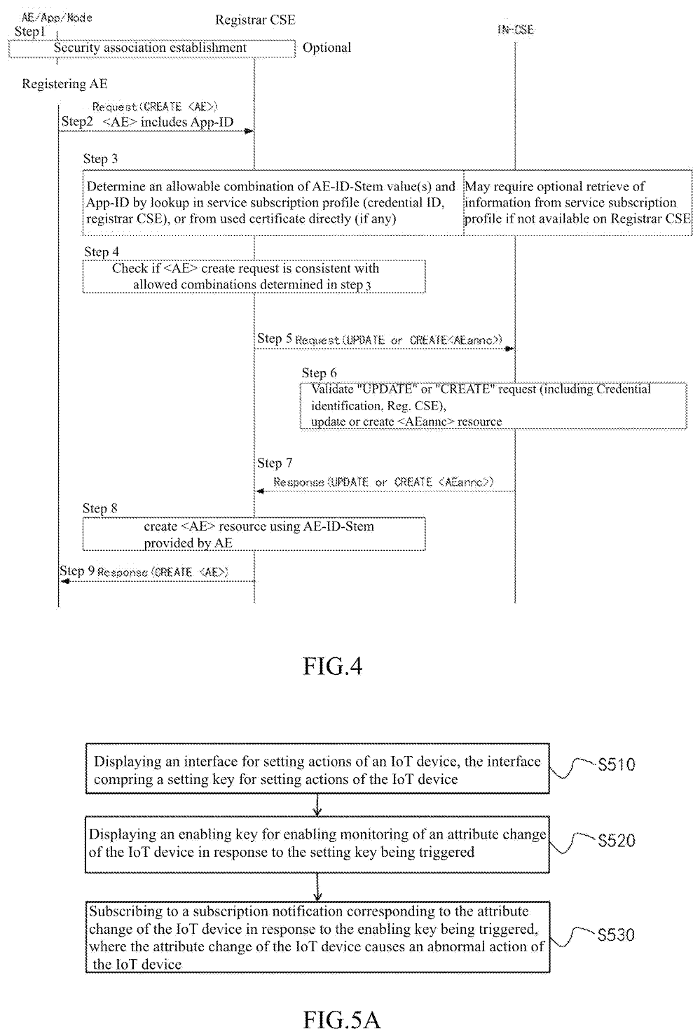

According to an embodiment of the present disclosure, the subscription notification may be triggered by an attribute change of the application entity caused by re-registration of the monitored application entity. A registration procedure of an application entity will be described later with reference to FIG. 4, which will not be repeatedly described herein.

As an example, the monitored application entity may be an air-conditioning device and an air purification device.

As an example, the subscription notification may be triggered by a change of an attribute corresponding to the air conditioner caused by re-energization of the air conditioner.

As an example, the subscription notification may be triggered after the air purification device is sold by a seller to a buyer and powered on by the buyer, and the subscription notification is sent to the seller's terminal device (e.g., a mobile APP).

According to an embodiment of the present disclosure, before receiving the subscription notification corresponding to the action resource associated with the monitored application entity, it may further include: sending a request to change the resource attribute of the monitored application entity; receiving a response to a change of the resource attribute of the monitored application entity.

As an example, the monitored application entity may be a temperature sensor. In this case, the ASN-AE may send a request to the CSE to change the location information in the resource attribute of the temperature sensor, such as unchecking the previous location “living room” of the temperature sensor and checking “balcony”, so as to complete the change of the location information in the resource attribute of the temperature sensor.

As an example, after processing the above change request, the CSE end will send a response of success change to the ASN-AE (such as a mobile APP), and at this time, the ASN-AE will receive the response of resource attribute change of the ADN-AE (such as the temperature sensor).

According to an embodiment of the present disclosure, the subscription notification may be triggered by the change of the resource attribute of the monitored application entity.

As an example, in the case that the monitored application entity is a temperature sensor, the subscription notification may be triggered by the change of the location information in the resource attribute of the temperature sensor. For example, the temperature sensor is moved from the living room to the bedroom and triggers the subscription notification after the terminal device (such as a mobile APP) completes the location change.

According to an embodiment of the present disclosure, the action resource is created after the monitored application entity completes an initial registration, and a registration procedure of the application entity will be described later with reference to FIG. 4, which will not be repeatedly described herein.

As an example, the action resource may also be created after the monitored application entity completes re-registration. That is, the action resource is created after the monitored application entity completes at least one registration.

As an example, after the temperature sensor and air-conditioning device complete registration with the CSE, the ASN-AE may send a request to the CSE to create an action resource “Turn on the air conditioner in the living room when the temperature sensor detects that the ambient temperature in the living room is greater than 31 degrees Celsius”.

The method for subscription notification performed by an application entity ASN-AE (such as a mobile APP) in an application service node is described in detail above with reference to FIG. 2. It can be seen from the above content that, after the ADN-AE completes registration, the ASN-AE may send a request for creating an action resource to the CSE, and include information associated with the monitored application entity in the request, so that a subscription notification can be triggered in time after an attribute change of the monitored application entity, and the ASN-AE (such as a mobile app) can receive the subscription notification corresponding to the action resource of the monitored application entity in time. Therefore, the user can learn a previously set intelligent scene related to the monitored application entity in time, so as to decide whether the relevant intelligent scene continues to be valid or invalid, which not only conforms to actual operation practices of the user, but also can improve the user's IoT experience.

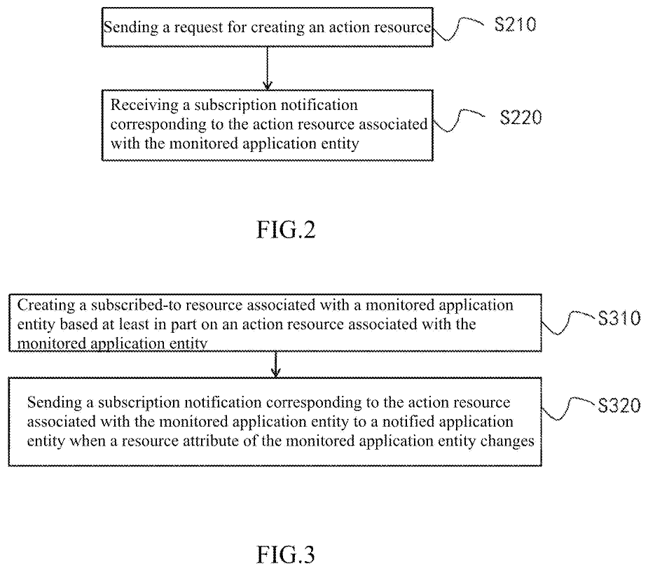

After the detailed description of the method for subscription notification performed by the ASN-AE in conjunction with FIG. 2, a method for subscription notification performed by a common service entity will described in detail in conjunction with FIG. 3.

FIG. 3 shows a flowchart of a method for subscription notification performed by a common service entity according to an embodiment of the present disclosure.

Referring to FIG. 3, at S310, a subscribed-to resource associated with a monitored application entity may be created based at least in part on an action resource associated with the monitored application entity.

According to an embodiment of the present disclosure, a plurality of action resources associated with a plurality of application entities may be created on the common service entity CSE, and the monitored application entity is one of the plurality of application entities.

As an example, the following action resources related to a temperature sensor, a humidity sensor, an air-conditioning device and a humidifying device may be created on the CSE:

Action resource 1: “Turn on the air-conditioning device in the living room when the temperature sensor detects that the ambient temperature in the living room is greater than 31 degrees Celsius”;

Action resource 2: “Turn off the air-conditioning device in the living room when the temperature sensor detects that the ambient temperature in the living room is less than 16 degrees Celsius”;

Action resource 3: “Turn on the humidifying device in the living room when the humidity sensor detects that the humidity in the living room is less than 25%”;

In the case that the monitored application entity is a temperature sensor, the action resources 1 and 2 among the above action resources 1 to 3 are related to the temperature sensor, so a subscribed-to resource associated with the temperature sensor may be created based on the action resources 1 and/or 2.

According to an embodiment of the present disclosure, the creation of the action resource associated with the monitored application entity may include creating the action resource associated with the monitored application entity in response to receiving a request to create the action resource.

As an example, the creation of the above action resource 1 may be in response to receiving a request from the ASN-AE to create the following action resource: “Turn on the air-conditioning device in the living room when the temperature sensor detects that the ambient temperature in the living room is greater than 31 degrees Celsius”, which is created by the CSE and is associated with the monitored application entity (such as the temperature sensor).

According to an embodiment of the present disclosure, the subscribed-to resource may include an event notification criteria attribute, and the event notification criteria of the subscribed-to resource may include a registration monitoring attribute, wherein the creation of the subscribed-to resource associated with the monitored application entity may further include: adding an identifier of the monitored application entity to a subscription monitoring list corresponding to the registration monitoring attribute.

According to an embodiment of the present disclosure, as shown in Tables 1 and 2 below, Table 1 shows related attributes of a <subscription> resource, including the event notification criteria (eventNotificationCriteria) attribute. The contents shown in Table 1 are only exemplary, and it may also include other contents, which will not be repeatedly described herein.

Table 2 shows related attributes (such as registration monitoring (regMonitor) attribute) included in the event notification criteria attributes included in the subscribed-to resource. The contents shown in Table 2 are only exemplary, and it may also include other contents, which will not be repeatedly described herein.

As shown in Table 2, the identifier of the monitored application entity (such as AE-ID-stem of the temperature sensor) may be added to the corresponding subscription monitoring list of the regMonitor attribute.

TABLE 1
Attributes of the subscribed-to resource

| Attributes of | | RW/RO/ | |
|---|---|---|---|
| subscription | Multiplicity | WO | Description |
| eventNotificationCriteria | 0 . . . 1 | RW | This attribute (notification policy) |
| | | | indicates an event criterion for which a |
| | | | notification is to be generated. When no |
| | | | eventNotificationCriteria attribute is |
| | | | present in a <subscription> resource, the |
| | | | Hosting CSE shall trigger notifications for |
| | | | this subscription when any of the |
| | | | attributes of the subscribed-to resource is |
| | | | modified. |
| expirationCounter | 0 . . . 1 | RW | This attribute (notification policy) |
| | | | indicates that the subscriber wants to set |
| | | | the life of this subscription to a limit of a |
| | | | maximum number of notifications. When |
| | | | the number of notifications sent reaches |
| | | | the count of this counter, |
| | | | the <subscription> resource shall be |
| | | | deleted, regardless of any other policy. |
| notificationURI | 1 (L) | RW | This attribute shall be configured as a list |
| | | | consisting of one or more targets that the |
| | | | Hosting CSE shall send notifications to. |

TABLE 2
eventNotificationCriteria conditions

| Condition tag | Multiplicity | Matching condition |
|---|---|---|
| operationMonitor | 0 . . . n | The operations and/or the Originators accessing |
| | | the subscribed-to resource matches with the |
| | | specified value. It allows monitoring which |
| | | operation and/or which Originator is attempting |
| | | to the access subscribed-to resource regardless of |
| | | whether the operation is performed. This feature |
| | | is useful to detect application entities (AEs) that |
| | | send requests to a subscribed-to resource and that |
| | | result in a successful or failure response. Possible |
| | | arguments are operation(s) (e.g.: CREATE, |
| | | RETRIEVE, UPDATE, DELETE, NOTIFY) |
| | | and/or Originator identifier(s). |
| | | If a set of Originator identifier(s) is included in |
| | | this tag and no operations are listed, any |
| | | operations initiated from any of the indicated |
| | | Originator(s) shall trigger a notification. |
| | | If a set of operation(s) is included in this tag and |
| | | no Originator identifier, any of the listed |
| | | operations shall trigger a notification. |
| | | If both, a set of Originator identifiers and a set of |
| | | operations are listed, then any of the listed |
| | | operations initiated from any of the listed |
| | | Originators shall trigger the notification. |
| regMonitor | 0 . . . n | The value of this attribute is a list of application |
| | | entity identifiers (AE-ID-Stem). The list is only |
| | | applicable when this <subscription> is created |
| | | under <CSEBase> or <remoteCSE>. The |
| | | Hosting CSE keep monitoring the re-registration |
| | | status of the Application Entity recorded in the |
| | | list |

In Table 1 and Table 2, the value “0 . . . 1” indicates that child resources/attributes may exist; the value “0 . . . n” indicates that child resources/attributes may exist, and if so, multiple instances are supported; the attribute multiplicity with (L) fixed afterward indicates that it is a list of values; RW means read and write.

According to an embodiment of the present disclosure, as shown in Table 2, identifiers of all application entities that need to be monitored will be added to the above subscription monitoring list (i.e. AE-ID-Stem list). In particular, the CSE will add an identifier of an application entity that needs to be monitored under <CSEBase> or <remoteCSE> to monitor a re-registration status of the monitored application entity, and the above re-registration status may be triggered by re-registration of the monitored application entity or a change of the resource attribute of the monitored application entity.

As an example, after creating subscribed-to resources associated with resources of the temperature sensor and/or the air-conditioning device, the CSE will put identifiers of the temperature sensor and/or the air-conditioning device under <CSEBase> or <remoteCSE>, that is, add them to the subscription monitoring list, so as to monitor their re-registration status.

According to an embodiment of the present disclosure, creating the subscribed-to resource associated with the monitored application entity may include: in response to receiving a request to create the subscribed-to resource for the monitored application entity, creating the subscribed-to resource associated with resources of the monitored application entity, and adding the identifier of the monitored application entity to the subscription monitoring list.

As an example, the ASN-AE may send a request to the CSE to create a subscribed-to resource for the temperature sensor, and after receiving the above request, the CSE may create the subscribed-to resource associated with resources of the temperature sensor, and add the identifier of the temperature sensor (such as AE-ID-stem) to the subscription monitoring list (i.e., add the identifier under <CSEBase> or <remoteCSE>) to realize monitoring of the resources of the temperature sensor.

Referring back to FIG. 3, after the subscribed-to resource is created, at step S320, if the resource attribute of the monitored application entity is changed, a subscription notification corresponding to the action resource associated with the monitored application entity may be sent to a notified application entity.

As an example, the monitored application entity may be a temperature sensor. When the resource attribute of the temperature sensor changes, the CSE may send a subscription notification corresponding to the action resource associated with the temperature sensor to, for example, an application entity in the ASN-AE or an intermediate node (such as a gateway).

According to an embodiment of the present disclosure, determination that the resource attribute of the monitored application entity is changed may include: receiving a re-registration request of the monitored application entity; comparing a resource attribute of the re-registered monitored application entity with the resource attribute of the monitored application entity before re-registration, and determining whether the resource attribute of the monitored application entity is changed, wherein a registration procedure of the application entity will be described later with reference to FIG. 4, which will not be repeatedly described herein.

As an example, the monitored application entity may be an air purifier with Global Positioning System (GPS) function. In this case, the air purifier is located in the living room before moving, and sends an initial registration request to the CSE, which registers the air purifier after receiving the initial registration request. At this time, a resource attribute of the registered air purifier includes location information (living room), identifier, etc. After moving the air purifier to the bedroom, the air purifier sends a re-registration request to the CSE after being powered on, and the CSE re-registers the air purifier after receiving the re-registration request. At this time, the resource attribute of the air purifier includes location information (bedroom), identifier, etc. Then, the CSE compares resources of the air purifier before and after re-registration. At this time, the resource attribute of the air purifier is changed, that is, it can be determined that the resource attribute of the air purifier is changed.

As an example, the monitored application entity may be a smart light bulb. In this case, the smart light bulb sends an initial registration request to the CSE, which registers it after receiving the initial registration request. At this time, a resource attribute of the smart light bulb includes location information (such as living room), identifier, etc. Then, after the living room is powered off and powered on again, the smart light bulb sends a re-registration request to the CSE, and the CSE re-registers it after receiving the re-registration request. At this time, the resource attribute of the smart light bulb includes location information (such as living room), identifier, etc. Then, the CSE compares resources of the smart bulb before and after re-registration. At this time, the resource attribute of the smart bulb has not changed, that is, it can be determined that the resource attribute of the smart bulb has not changed.

Optionally, according to an embodiment of the present disclosure, the determination that the resource attribute of the monitored application entity is changed may include: in response to receiving a request to change the resource attribute of the monitored application entity, determining to change the resource attribute of the monitored application entity.

As an example, the monitored application entity may be a temperature sensor. In this case, the ASE-AE may send a request to the CSE to change the resource attribute of the temperature sensor, such as changing the location information in the resource attribute of the temperature sensor from “living room” to “bedroom”. Then, after CSE receives the request to change the resource attribute of the temperature sensor, it can be determined that the resource attribute of the temperature sensor has been changed.

According to an embodiment of the present disclosure, the action resource associated with the monitored application entity may be created after the monitored application entity completes initial registration.

As an example, after initial registration of the temperature sensor or air-conditioning device with the CSE, the action resource associated with the temperature sensor or air-conditioning device may be created. Of course, the action resource associated with the temperature sensor or air-conditioning device may also be created after re-registration of the temperature sensor or air-conditioning device with the CSE. That is, an IoT device (such as the temperature sensor or air-conditioning device) can only create an action resource associated with the IoT device (such as the temperature sensor or air-conditioning device) after registering with the CSE at least once.

According to an embodiment of the present disclosure, the subscription notification may include at least one of: a notification on invalidation of the current action resource of the monitored application entity, a notification on an action resource list associated with the monitored application entity, and a notification on revalidation of the action resource of the monitored application entity.

As an example, the monitored application entity may be a temperature sensor, assuming that the following action resources are set for the temperature sensor:

Action resource 1: “Turn on the air conditioner in the living room when the temperature sensor detects that the ambient temperature in the living room is greater than 31 degrees Celsius”;

Action resource 2: “Open the windows in the living room when the temperature sensor detects that the ambient temperature in the living room is greater than 31 degrees Celsius”;

Action resource 3: “Close the windows in the living room when the temperature sensor detects that the ambient temperature in the living room is less than 15 degrees Celsius”;

As an example, when the temperature sensor is moved from the living room to the bedroom, the notified application entity (such as an application entity in ASN-AE or an intermediate node (such as a gateway)) may receive a notification that the current action resource 1 of the temperature sensor is invalid.

As an example, when the temperature sensor is moved from the living room to the bedroom, the notified application entity (such as an application entity in ASN-AE or an intermediate node (such as a gateway)) may receive a notification of a list of action resources 2 to 3 associated with the temperature sensor. Optionally, in the notification, a key may be set at a location corresponding to an action resource for the user to select to determine whether the corresponding action resource continues to be valid or invalid.

As an example, when the temperature sensor is moved from the living room to the bedroom and then moved from the guest bedroom to the living room again, the notified application entity (such as an application entity in ASN-AE or an intermediate node (such as a gateway)) may receive a notification that the action resource 3 of the temperature sensor is valid again.

According to an embodiment of the present disclosure, after the action resource is created as described above, a value of an activation status attribute of the action resource may be set to enable monitoring of the action resource.

According to an embodiment of the present disclosure, as shown in Table 3 below, Table 3 shows part of content of attributes of the <action> resource, and it may also include other contents, which will not be repeatedly described herein.

In Table 3, the value of the activation status attribute of the action resource (shown as ActiveStatus in Table 3) may be set by the CSE to a value that enables monitoring of the action resource (i.e., set to TRUE) after the action resource is created.

TABLE 3
Attributes of the action resource

| | | RW/RO/ | | <actionAnnc> |
|---|---|---|---|---|
| Attributes of <action> | Multiplicity | WO | Description | Attributes |
| actionSubjectResource | 0 . . . 1 | RW | The resource that is the subject | OA |
| | | | to be monitored for triggering | |
| | | | the evaluation of the | |
| | | | evalCriteria attribute. The | |
| | | | action indicated by the | |
| | | | operation attribute Action is to | |
| | | | be triggered based on the | |
| | | | change of the state of the | |
| | | | resource indicated by the | |
| | | | actionSubject Resource | |
| | | | attribute. The subject can be | |
| | | | any resource in the system. If | |
| | | | the attribute is missing, the | |
| | | | subject is the parent resource. | |
| actionPriority | 0 . . . 1 | RW | Attribute indicating the | OA |
| | | | priority of the action when | |
| | | | compared with the other | |
| | | | actions with the same event | |
| | | | expression | |
| | | | (subjectResourceID and | |
| | | | evalCriteria), with highest | |
| | | | priority indicated by the lowest | |
| | | | value. Local policies are | |
| | | | applied for equal or | |
| | | | unspecified priorities. | |
| subjectResourceID | 0 . . . 1 | RW | The resourceID of the resource | OA |
| | | | that is the subject of | |
| | | | monitoring for evaluation of | |
| | | | the evalCriteria attribute. The | |
| | | | subject can be any resource in | |
| | | | the system. If the attribute is | |
| | | | missing, the subject is the | |
| | | | parent resource of this | |
| | | | <action> resource. | |
| evalCriteria | 0 . . . 1 | RW | This attribute provides the | OA |
| | | | conditions determining if the | |
| | | | action is to be conditionally | |
| | | | triggered to the object | |
| | | | resource. | |
| | | | The evalCriteria attribute, in | |
| | | | conjunction with the | |
| | | | subjectResourceID, forms the | |
| | | | event expression that is being | |
| | | | monitored. See further | |
| | | | description below and in table | |
| | | | 9.6.61-3.∘ | |
| evalMode | 1 | RW | Attribute provides the macro | OA |
| | | | control mode of the evaluation | |
| | | | of the <action> resource. | |
| | | | Some values are: | |
| | | | 0 = off | |
| | | | 1 = once | |
| | | | 2 = periodic | |
| | | | 3 = continuous | |
| evalControlParam | 0 . . . 1 | RW | When evalMode = periodic, | OA |
| | | | evalControlParam represents | |
| | | | the periodicity. | |
| | | | When evalMode = continuous | |
| | | | the evaluation is restarted as | |
| | | | soon as an action has been | |
| | | | triggered. In this case, if | |
| | | | evalControlParam is | |
| | | | specified, it determines the | |
| | | | number of times the Hosting | |
| | | | CSE shall trigger the event, | |
| | | | otherwise it is repeated | |
| | | | indefinitely. | |
| | | | When evalMode is off or once | |
| | | | this attribute can be ignored. | |
| evalPriority | 0 . . . 1 | RW | List of priorities to be applied | OA |
| | (L) | | for the evaluation of the | |
| | | | dependencies. is is an | |
| | | | ordered list of the resourceIDs | |
| | | | of the child <dependency> | |
| | | | resources. | |
| activeStatus | 1 | RW | Status switch of the action | OA |
| | | | resource. If activeStatus is | |
| | | | TRUE, related action | |
| | | | resources are monitored and a | |
| | | | subsequent triggering process | |
| | | | is processed. If the attribute | |
| | | | value is FALSE, the related | |
| | | | action resources will not be | |
| | | | monitored and the subsequent | |
| | | | triggering process will not be | |
| | | | carried out. | |

In Table 3, the value “0 . . . 1” indicates that child resources/attributes may exist; the value “1” indicates that there should be child resources/attributes; the attribute multiplicity with (L) fixed afterward indicates that it is a list of values; RW means read and write; MA means Mandatory Announced, that is, attributes in original resources are announced to the announced resources, so that content of an announced attribute is the same as that of the original attribute; OA means Optional Announced, that is, the attributes in the original resources may be announced to the announced resources according to contents of attributes announced at the original resources, so that content of an announced attribute is the same as that of the original attribute.

As an example, after the CSE creates an action resource such as “Turn on the air conditioner in the living room when the temperature sensor detects that the ambient temperature in the living room is greater than 31 degrees Celsius”, it can set the value of ActiveStatus to TRUE, so that the above action resource created in the CSE will be monitored by the CSE, and after a primary event is triggered, it will continue to check relevant dependencies to determine to trigger related actions. For example, when the temperature monitoring indicates that the ambient temperature in the living room is greater than 31 degrees Celsius, the CSE monitors that a trigger condition in the above-mentioned action resource has been met, and then executes the corresponding action in the above-mentioned action resource, that is, turns on the air conditioner in the living room, so that the above-mentioned action resource can be normally realized.

According to an embodiment of the present disclosure, after sending the subscription notification corresponding to the action resource associated with the monitored application entity to the notified application entity, it may further include: in response to receiving an indication that the action resource of the monitored application entity is invalid, setting the value of the activation status attribute of the action resource to disable monitoring of the action resource.

As an example, the CSE may set the value of ActiveStatus to FALSE in response to receiving an indication that the action resource “Turn on the air conditioner in the living room when the temperature sensor detects that the ambient temperature in the living room is greater than 31 degrees Celsius” is invalid, so as not to perform related monitoring of the above action resource.

As an example, the indication that the action resource is invalid may be obtained by the user selecting a relevant key in an interface for the relevant subscription notification, or based on a rule predefined in the IoT management platform.

As an example, in the interface for the relevant subscription notification, after the action “Turn on the air conditioner in the living room when the temperature sensor detects that the ambient temperature in the living room is greater than 31 degrees Celsius”, keys may be set to select to decide whether the above action continues to be valid or invalid. When the user selects an invalid key, the CSE will set the value of ActiveStatus to FALSE, so that after a primary event is triggered, it will not continue to check relevant dependencies to determine to trigger related actions. For example, when the temperature monitoring shows that the ambient temperature in the living room is greater than 31 degrees Celsius, the air conditioner in the living room will not be turned on, which makes the above-mentioned action resource cannot be realized, that is, becomes invalid.

As an example, a seller sets an action about an air purifier in his/her living room, then sells the air purifier to a buyer, and the buyer sets an action about the air purifier in his/her bedroom. At this time, the IoT management platform can determine that an action resource about this air purifier among action resources set by the seller is invalid according to information such as a distance between the buyer and the seller, access points and the like. Then not only the seller can receive a subscription notification on invalidation of the action resource of this air purifier via, for example, an application entity in ASN-AE or an intermediate node (such as a gateway), but also the CSE will set the value of ActiveStatus to FALSE according to an indication of invalidation of the above action resource, so that the air purifier will not be continuously monitored.

The method for subscription notification performed by a common service entity is described in detail above in connection with FIG. 3 and Tables 1-3. From the above content, it can be seen that the above method for subscribing notification provided by the present disclosure can closely combine subscribed-to resources with action triggering, and when a resource attribute of a monitored application entity changes, it can timely send a subscription notification corresponding to an action resource associated with the monitored application entity to a notified application entity, so that the notified application entity can timely learn whether the relevant action resource of the monitored application entity is valid or invalid, and further trigger the related action, which better conforms to actual operation practices of users and enhances IoT experience of users.

Therefore, subscribed-to resources and action resources are closely combined. A process for managing action triggering of an IoT device via <action> resources and <dependency> resources is described below.

An <action> resource is created when a user wants to cause the IoT device to perform a specific action in response to detecting an event of a specific intelligent scene. The event has an object resource associated with it—a change of this object resource causes a hosting CSE to conditionally trigger a target action of the object resource. The object is identified by a subjectResourceID attribute of the <action> resource, and an evalCriteria attribute of the <action> resource determines whether the action is triggered conditionally. Generally, this combination is called event expression, and the event is a primary event when triggered.

To handle more complex events, one or more <dependency> resources may be created as child resources of the <action> resource. Within a <dependency> resource, a dependentResourceID attribute identifies a resource on which the event depends. An evalCriteria attribute of the <dependency> resource determines whether a dependency condition is met. A logic attribute determines whether the dependency condition is SUFFICIENT or NECESSARY for action triggering. Finally, an evalPriority attribute of the <action> resource determines priorities of dependency conditions to be applied when evaluating whether actions or operations should be triggered based on the primary event. The hosting CSE will evaluate the dependency conditions according to a priority order of evalPriority.

The following describes a procedure the hosting CSE performs to manage monitoring of events and, when they occur, conditional triggering of actions and operations specified, as detailed by the following the steps:

Step 1: CSE creates <action> resource either as a child resource of a subject resource or elsewhere in a resource tree. The subject resource can be any of the resources, and is indicated by the subjectResourceID attribute. CSE may create one or more <dependency> resources as child resources of the <action> resource.

Changes to the subject resource possibly trigger evaluation of evalCriteria.

Step 2: CSE determines whether the attribute or child resource of the subject resource is changed. If so, CSE will update the subject.

Step 3: The Hosting CSE gets the updated result and evaluates if the updated subject resource, and if it matches the criteria defined in the evalCriteria attribute of the <action> resource, the primary event is considered triggered.

Step 4: If the ActiveStatus attribute of the <action> resource is TRUE, the Hosting CSE proceeds to step 5. If the ActiveStatus attribute of the <action> resource is FALSE (e.g., due to invalid action resource caused by an attribute change of the subject resource), the subsequent triggering procedure is not executed.

Step 5: After a primary event is triggered at step 3, if there is at least one <dependency> child resource of the <action> resource, the Hosting CSE processes each <dependency> child resource(s) in the order provided in the evalPriority attribute, or in an order based on local policy if the attribute is missing.

From the above content, it can be seen that the method for subscription notification provided by the present disclosure adds a new step 4, namely, the judgment of ActiveStatus, in the above-mentioned action triggering procedure, so as to closely combine the subscription procedure with the action triggering procedure, better conform to actual operation practices of users, and enhance IoT experience of users.

In the above method for subscription notification provided by the present disclosure, registration of the application entity is used. Next, a registration solution will be introduced with reference to FIG. 4.

FIG. 4 shows a flowchart of an application entity (AE) or an application program (APP) or a Node registering with a Common Service Entity (CSE).

Referring to FIG. 4, the registration of an application entity (AE) or an application program (APP) or a Node with a common service entity (CSE) includes the following steps and situations.

Step 1 (optional): AE or APP or Node establishes security association with CSE, the registrar.

Step 2: AE or APP or Node sends a request for creating an AE resource to the registrar CSE, and the request includes its identifier (such as App-ID, AE-ID-Stem), that is, sends Request (CREATE <AE>) to the registrar CSE.

Step 3: Registrar CSE determines an allowable combination of AE-ID-Stem value and App-ID by lookup in a service subscription profile (credential ID, registrar CSE), or from a used certificate directly (if any).

May require optional retrieve of information from the service subscription profile if not available on the registrar CSE.

Step 4: Check if the <AE> create request is consistent with the allowed combinations determined in step 3.

The following steps may be applied to an initial registration and re-registration procedure of AE (such as the thermometer mentioned above), as follows:

At first, AE provides CSE with AE identifier AE-ID-Stem (that is, the identifier specified by AE) beginning with ‘S’, and then, the following steps are carried out: Step 5: The registrar CSE sends a request for updating or creating an AE announcement to the IN-CSE, that is, sending Request (UPDATE or CREATE <AEannc>), where creating AE means to initiate a registration procedure and updating AE means to initiate a re-registration procedure.

Step 6: IN-CSE verifies the “UPDATE” or “CREATE” request (including credential identification and reg. CSE), and updates or creates the <AEannc> resource.

Step 7: IN-CSE sends a corresponding response to the registrar CSE, that is, sends Response (UPDATE or CREATE <AEannc>).

Step 8: The registrar CSE creates the <AE> resource using AE-ID-Stem provided by AE.

Step 9: The registrar CSE sends a response to the creation to AE or APP or Node, that is, sends Response (CREATE <AE>).

Therefore, AE (such as the above temperature sensor) may complete the initial registration by using the above registration procedure. However, when an attribute of AE changes (for example, the temperature sensor is moved from the bedroom to the balcony), AE may inform CSE of its attribute change through re-registration, that is, re-registration may be completed through the above registration procedure to inform CSE of its attribute change.

Furthermore, it can be seen from the above re-registration procedure that AE follows the AE-ID-Stem for the first registration. Therefore, in the process of re-registration, even if the attribute of AE changes, AE-ID-Stem of AE does not change. Therefore, even if the attribute of AE changes due to re-registration, CSE can further determine whether to send a subscription notification to ASN-AE by determining whether AE-ID-Stem of the re-registered AE is in the subscription monitoring list of subscribed-to resources, so as to inform ASN-AE whether the action resource associated with the re-registered AE is invalid.

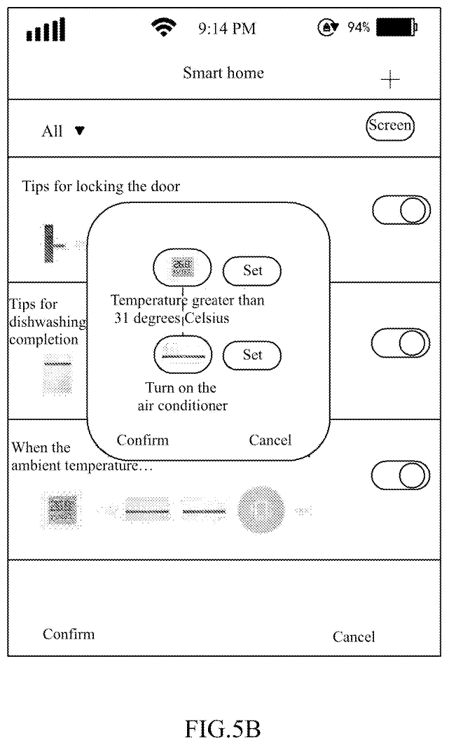

In addition to the above method for subscription notification, the embodiments of the present disclosure also provide a method performed by a terminal for IoT, which will be described in detail next with reference to FIGS. 5A to 5C.

FIG. 5A shows a flowchart of a method performed by a terminal for IoT according to an embodiment of the present disclosure. The terminal may be a handheld device (such as a mobile phone), a tablet and the like.

Referring to FIG. 5A, at step S510, an interface for setting actions of an IoT device may be displayed, and the interface may include a setting key for setting actions of the IoT device.

As an example, the IoT device may be a temperature sensor and an air-conditioning device.

As an example, as shown in FIG. 5B, the currently displayed interface is the interface for setting actions of the temperature sensor and/or air-conditioning device, where the setting key corresponding to the temperature sensor or air-conditioning device may be clicked by the user to set actions of the temperature sensor or air-conditioning device.

At step S520, after the user clicks the above setting key, the device for IoT may display an enabling key for enabling monitoring of attribute changes of the IoT device in response to the setting key being triggered.

As an example, when the user clicks the setting key corresponding to the temperature sensor, an attribute change monitoring interface as shown in FIG. 5C will pop up. In this interface, related attributes that can enable attribute change monitoring are listed, such as location, expiration time, label, etc., and enabling keys which the user can select are set at locations corresponding to the related attributes shown. In addition, when the last enabling key in FIG. 5C is selected, it means that all attribute changes are monitored.

At step S530, in response to the enabling key being triggered, a subscription notification corresponding to an attribute change of the IoT device may be subscribed, where the attribute change of the IoT device leads to an abnormal action of the IoT device.

For example, when the user selects an enabling key corresponding to the location attribute, the location attribute of the temperature sensor will be monitored, that is, the user will subscribe to a subscription notification corresponding to a change of the location attribute of the temperature sensor. When the location attribute of the temperature sensor changes, previously set actions of the temperature sensor will be abnormal, for example, the previously set actions will not be executed.

According to an embodiment of the present disclosure, before displaying the interface for setting action resources of the IoT device, it may include: displaying an action creation interface for creating an action associated with the IoT device, and the action creation interface includes at least one of: a selection box for setting content of the action, a selection box for setting a valid condition of the action, and a selection box for setting attributes of the IoT device associated with the action.

As an example, before displaying the interface for setting action resources of the IoT device, an interface for action creation may be displayed, in which a selection box for setting content of action may be included. In the selection box, for example, it may be selected to turn on related devices if a condition is met, or turn on related devices if they are moved, etc. The interface may also include a selection box for setting a valid condition of the action, such as making the action valid at 16:00 every day. The interface may also include a selection box for attributes of the IoT device associated with the action, such as a selection box for attributes of a temperature sensor associated with the action, in which related attributes of the temperature sensor, such as locations, are selected.

According to an embodiment of the present disclosure, before displaying the interface for creating actions associated with the IoT device, it may include: displaying a registration interface for registering the IoT device, and the registration interface may include a key for initiating registration of the IoT device.

As an example, in the registration interface, registration of a temperature sensor may be initiated, such as registering with a home gateway.

According to an embodiment of the present disclosure, the subscription notification may be triggered by an attribute change of the IoT device caused by re-registration of the IoT device.

As an example, the IoT device may be an air purifier, and the subscription notification is triggered when an attribute of the air purifier is changed due to re-registration.

According to an embodiment of the present disclosure, the subscription notification is used for at least one of: notification on the current action resource of the IoT device being invalid, notification on an action resource list associated with the IoT device, and notification on revalidation of the action resource of the IoT device.

As an example, the IoT device may be a temperature sensor, and the following actions are set with respect to the temperature sensor:

Action resource 1: “Turn on the air-conditioning device in the living room when the temperature sensor detects that the ambient temperature in the living room is greater than 31 degrees Celsius”;

Action resource 2: “Open the window device in the living room when the temperature sensor detects that the ambient temperature in the living room is greater than 31 degrees Celsius”;

Action resource 3: “Close the windows in the living room when the temperature sensor detects that the ambient temperature in the living room is less than 15 degrees Celsius”.

As an example, when the temperature sensor is moved from the living room to the bedroom, the subscription notification may be used for a notification that the current action resource 1 of the temperature sensor is invalid.

As an example, when the temperature sensor is moved from the living room to the bedroom, the subscription notification may be used for a notification of a list of the action resources 2 to 3 associated with the temperature sensor.

As an example, when the temperature sensor is moved from the living room to the bedroom and then the temperature sensor is moved from the guest bedroom to the living room again, the subscription notification may be used for a notification that the action resource 3 of the temperature sensor is valid again.

The method performed by a terminal for IoT is described in detail above with reference to FIGS. 5A to 5C. According to the method provided by the present disclosure, the user can monitor changes of related attributes of IoT devices on the terminal for IoT, and subscribe to corresponding subscription notification, so as to timely monitor attribute changes of the IoT devices, make related actions abnormal, which conforms to actual operation practices of users, and enhances IoT experience of users.

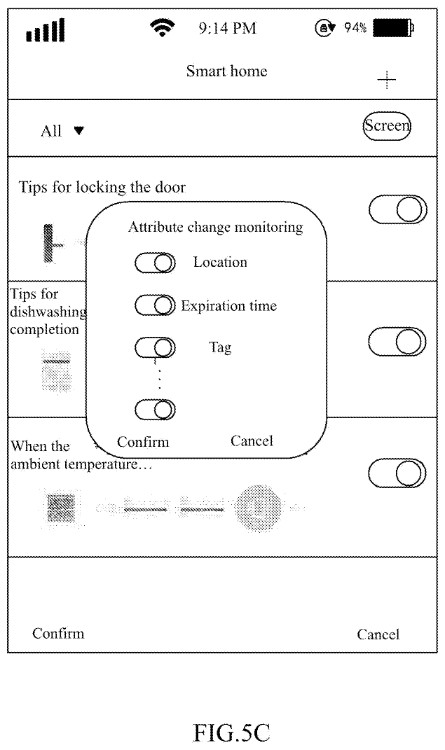

Next, the content described above will be introduced by an example with reference to FIG. 6.

FIG. 6 shows an interaction diagram between a common service entity and an application entity according to an embodiment of the present disclosure.

As shown in FIG. 6, participants in the whole interaction process include a first AE (e.g., ASN-AE, an application in a mobile phone), CSE (e.g., a home gateway) and a second AE (e.g., ADN-AE, a thermometer).

At step S610, the first AE sends a registration request to the CSE. After receiving the registration request and creating resources corresponding to the first AE, the CSE sends a registration creation response to the first AE at step S620 to indicate that the registration is successful (see the foregoing FIG. 4 for the specific registration procedure).

At step S630, the second AE sends a registration request to the CSE. After receiving the registration request and creating resources corresponding to the second AE, the CSE sends a registration creation response to the second AE at step S640 to indicate that the registration is successful (see the foregoing FIG. 4 for the specific registration procedure).

At step 650, the first AE sends a request to the CSE to create an action resource “Turn on the air conditioner when the temperature sensor detects that the ambient temperature is greater than 31 degrees Celsius”. After receiving the request and creating the corresponding action resource, the CSE sends an action resource creation response to the first AE at step S660 to indicate that the action resource creation is successful.

At step S670, the CSE creates a subscribed-to resource associated with a monitored application entity (such as the temperature sensor), and adds an identifier of the temperature sensor to a subscription monitoring list.

At step S680, the first AE sends a request to the CSE to change an attribute of resources of the second AE (such as the temperature sensor), such as changing the location of the temperature sensor from “living room” to “bedroom”. After receiving and processing the above change request, the CSE sends an attribute change response to the first AE at step S690 to indicate that the change is successful.

At step S6110, the CSE checks whether there is an identifier identical to the identifier of the temperature sensor in the subscription monitoring list, and if there is, the CSE sends a notification of the subscription to the first AE at step S6120. The details of the notification can be found in the foregoing relevant introduction with reference to FIGS. 1A to 5C, which will not be repeatedly described herein.

At step S6130, the second AE (e.g., the temperature sensor) sends a re-registration request to the CSE, in which the location of the second AE changes. After receiving the re-registration request and creating resources corresponding to the re-registered second AE, the CSE sends a re-registration creation response to the second AE at step S6140, to indicate that the re-registration is successful (see the foregoing FIG. 4 for the specific registration procedure).

At step S6150, the CSE checks whether there is an identifier identical to the identifier of the temperature sensor in the subscription monitoring list, and if there is, the CSE sends a notification of the subscription to the first AE at step S6160. The details of the notification can be found in the foregoing relevant introduction with reference to FIGS. 1A to 5C, which will not be repeatedly described herein.

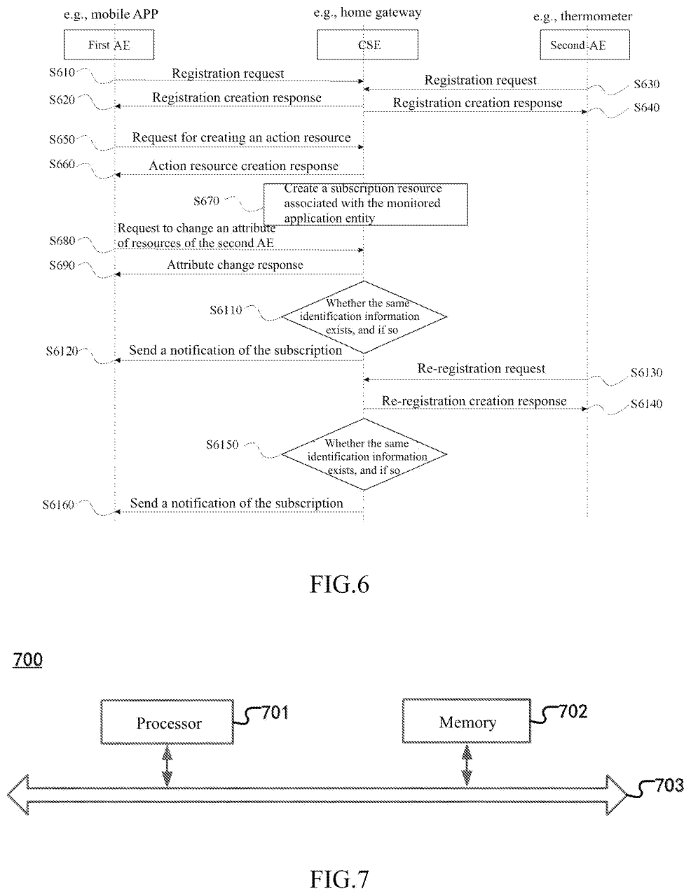

FIG. 7 shows a structural diagram of an electronic device 700 according to an embodiment of the present disclosure.

Referring to FIG. 7, the electronic device 700 may include a processor 701 and a memory 702. Both the processor 701 and the memory 702 can be connected by a bus 703. The virtual resource transfer device 700 may be a tower server, rack server, blade server, cabinet server and the like.

The processor 701 may perform various actions and processes according to programs stored in the memory 702. In particular, the processor 701 may be an integrated circuit chip with signal processing capability. The above processor may be a general-purpose processor, a Digital Signal Processor (DSP), an Application Specific Integrated Circuit (ASIC), a Field Programmable Gate Array (FPGA) or other programmable logic devices, discrete gate or transistor logic devices, and discrete hardware components. The methods, steps and logic diagrams disclosed in the embodiments of this application may be implemented or executed. The general-purpose processor may be a microprocessor or the processor may be any conventional processor, etc., which may be X86 architecture or ARM architecture.

The memory 702 stores computer instructions which, when executed by the processor 701, implement the above method 200 for sending cross-resource event notification. The memory 702 may be a volatile memory or a nonvolatile memory, or may include both volatile and nonvolatile memory. The nonvolatile memory may be Read Only Memory (ROM), Programmable Read Only Memory (PROM), Erasable Programmable Read Only Memory (EPROM), Electrically Erasable Programmable Read Only Memory (EEPROM) or flash memory. The volatile memory may be a Random-Access Memory (RANI), which is used as an external cache. By way of illustration but not limitation, many forms of RAM are available, such as Static Random-Access Memory (SRAM), Dynamic Random-Access Memory (DRAM), Synchronous Dynamic Random-Access Memory (SDRAM), Double Data Rate Synchronous Dynamic Random-Access Memory (DDRSDRAM), Enhanced Synchronous Dynamic Random-Access Memory (ESDRAM), Synchronous Linked Dynamic Random-Access Memory (SLDRAM) and Direct Memory Bus Random Access Memory (DR RAM). It should be noted that the memory of the methods described herein are intended to include, but are not limited to, these and any other suitable types of memories.

The disclosed embodiment also provides an apparatus for subscription notifications performed by a common service entity, which comprises a creation module configured to create a subscribed-to resource associated with a monitored application entity based at least in part on an action resource associated with the monitored application entity; and a notification module configured to send a subscription notification corresponding to the action resource associated with the monitored application entity to the notified application entity when a resource attribute of the monitored application entity changes.

The disclosed embodiment provides an apparatus for performing subscription notification, which comprises a sending module configured to send a request for creating an action resource, where the action resource is associated with a monitored application entity, and resource attributes of the monitored application entity are monitored for subscription notification; and a receiving module configured to receive a subscription notification corresponding to the action resource associated with the monitored application entity.

The disclosed embodiment provides a method performed by an IoT system, the IoT system comprising a common service entity, a monitored application entity and a notified application entity, the method comprising: sending, by the monitored application entity, a registration request to the common service entity; receiving, by the common service entity, the registration request of the monitored application entity, and sending a registration success response to the monitored application entity; sending, by the notified application entity, a registration request to the common service entity; receiving, by the common service entity, the registration request of the notified application entity, and sending a registration success response to the notified application entity; sending, by the notified application entity, a request for creating an action resource to the common service entity, the action resource being associated with the monitored application entity; receiving, by the common service entity, the request for creating an action resource sent by the notified application entity, and sending a creation success response to the notified application entity; creating, by the common service entity, a subscribed-to resource associated with the monitored application entity based at least in part on the action resource associated with the monitored application entity; and sending, by the common service entity, a subscription notification corresponding to the action resource associated with the monitored application entity to the notified application entity when a resource attribute of the monitored application entity changes

The present disclosure also provides a computer readable storage medium having stored thereon computer instructions, which when executed by a processor can implement the above methods. Similarly, the computer readable storage medium in the embodiments of the present disclosure may be volatile memory or nonvolatile memory, or may include both volatile and nonvolatile memory. It should be noted that the computer-readable storage media described herein are intended to include, but are not limited to, these and any other suitable types of memories.

It should be noted that the flowcharts and block diagrams in the accompanying drawings illustrate architectures, functions and operations of possible implementations of the systems, methods and computer program products according to various embodiments of the present disclosure. In this regard, each block in the flowcharts or block diagrams may represent a module, a program segment, or a part of code, which contains one or more executable instructions for implementing specified logical functions. It should also be noted that in some alternative implementations, the functions marked in the blocks may also occur in a different order than those marked in the drawings. For example, two consecutive blocks may actually be executed basically in parallel, and sometimes they may be executed in reverse order, depending on the functions involved. It should also be noted that each block in the block diagrams and/or flowcharts, and combination of blocks in the block diagrams and/or flowcharts, may be implemented by a dedicated hardware-based system that performs specified functions or operations, or may be implemented by a combination of dedicated hardware and computer instructions.

Generally, various exemplary embodiments of the present disclosure may be implemented in hardware or dedicated circuits, software, firmware, logic, or any combination thereof. Some aspects may be implemented in hardware, while others may be implemented in firmware or software that may be executed by a controller, microprocessor or other computing device. While aspects of the embodiments of the present disclosure are illustrated or described as block diagrams, flowcharts, or using some other graphical representations, it will be understood that the blocks, devices, systems, techniques, or methods described herein may be implemented as non-limiting examples in hardware, software, firmware, special-purpose circuits or logic, general-purpose hardware or controllers or other computing devices, or some combination thereof.

The exemplary embodiments of the present invention described in detail above are merely illustrative, not limiting. Those skilled in the art should understand that various modifications and combinations may be made to these embodiments or their features without departing from the principle and spirit of the present invention, and such modifications should fall within the scope of the present invention.

1. A method for subscription notification performed by a common service entity, comprising:
creating a subscribed-to resource associated with a monitored application entity based at least in part on an action resource associated with the monitored application entity; and
sending a subscription notification corresponding to the action resource associated with the monitored application entity to a notified application entity when a resource attribute of the monitored application entity changes.

2. The method for subscription notification of claim 1, wherein a plurality of action resources associated with a plurality of application entities are created on the common service entity, and the monitored application entity is one of the plurality of application entities.

3. The method for subscription notification of claim 1, wherein the creation of the action resource associated with the monitored application entity comprises:
creating the action resource associated with the monitored application entity in response to receiving a request to create the action resource.

4. The method for subscription notification of claim 1, wherein the subscribed-to resource comprises an event notification criteria attribute, and an event notification criterion for the subscribed-to resource comprises a registration monitoring attribute, wherein creating the subscribed-to resource associated with the monitored application entity further comprises:
adding an identifier of the monitored application entity to a subscription monitoring list corresponding to the registered monitoring attribute.

5. The method for subscription notification of claim 4, wherein creating the subscribed-to resource associated with the monitored application entity comprises:
in response to receiving a request to create a subscribed-to resource for the monitored application entity, creating the subscribed-to resource associated with resources of the monitored application entity, and adding the identifier of the monitored application entity to the subscription monitoring list.

6. The method for subscription notification of claim 3, wherein after the action resource is created, a value of an activation status attribute of the action resource is set to enable monitoring of the action resource.

7. The method for subscription notification of claim 1, wherein after sending the subscription notification corresponding to the action resource associated with the monitored application entity to the notified application entity, the method further comprises:
setting a value of an activation status attribute of the action resource to disable monitoring of the action resource in response to receiving an indication that the action resource of the monitored application entity is invalid.

8. The method for subscription notification of claim 1, wherein determination that the resource attribute of the monitored application entity is changed comprises:
receiving a re-registration request of the monitored application entity;
comparing a resource attribute of the re-registered monitored application entity with the resource attribute of the monitored application entity before re-registration, and determining whether the resource attribute of the monitored application entity is changed.

9. The method for subscription notification of claim 1, wherein determination that the resource attribute of the monitored application entity is changed further comprises:
determining to change the resource attribute of the monitored application entity in response to receiving a request to change the resource attribute of the monitored application entity.

10. The method for subscription notification of claim 1, wherein the action resource associated with the monitored application entity is created after the monitored application entity completes initial registration.

11. The method for subscription notification of claim 1, wherein the subscription notification is used for at least one of: notification on invalidation of a current action resource of the monitored application entity, notification on an action resource list associated with the monitored application entity, and notification on revalidation of the action resource of the monitored application entity.

12. A method performed by a terminal for Internet of Things (IoT), comprising:
displaying an interface for setting actions of an IoT device, wherein the interface comprises a setting key for setting actions of the IoT device;
displaying an enabling key for enabling monitoring of an attribute change of the IoT device in response to the setting key being triggered;
subscribing to a subscription notification corresponding to the attribute change of the IoT device in response to the enabling key being triggered, wherein the attribute change of the IoT device causes an abnormal action of the IoT device.

13. The method of claim 12, wherein before displaying the interface for setting actions of the IoT device, the method comprises:
displaying an action creation interface for creating an action associated with the IoT device, wherein the action creation interface comprises at least one of: a selection box for setting content of the action, a selection box for setting a valid condition of the action, and a selection box for setting attributes of the IoT device associated with the action.

14. The method of claim 13, wherein before displaying the interface for creating an action associated with the IoT device, the method comprises:
displaying a registration interface for registering the IoT device, wherein the registration interface comprises a key for initiating registration of the IoT device.

15. The method of claim 13, wherein the subscription notification is triggered by the attribute change of the IoT device caused by re-registration of the IoT device.

16. The method of claim 12, wherein the subscription notification is used for at least one of: notification on invalidation of a current action resource of the IoT device, notification on an action resource list associated with the IoT device, and notification on revalidation of the action resource of the IoT device.

17. A method performed by an Internet of Things (IoT) system, the IoT system comprising a common service entity, a monitored application entity and a notified application entity, the method comprising:
sending, by the monitored application entity, a registration request to the common service entity;
receiving, by the common service entity, the registration request of the monitored application entity, and sending a registration success response to the monitored application entity;
sending, by the notified application entity, a registration request to the common service entity;
receiving, by the common service entity, the registration request of the notified application entity, and sending a registration success response to the notified application entity;
sending, by the notified application entity, a request for creating an action resource to the common service entity, the action resource being associated with the monitored application entity;
receiving, by the common service entity, the request for creating an action resource sent by the notified application entity, and sending a creation success response to the notified application entity;
creating, by the common service entity, a subscribed-to resource associated with the monitored application entity based at least in part on the action resource associated with the monitored application entity; and
sending, by the common service entity, a subscription notification corresponding to the action resource associated with the monitored application entity to the notified application entity when a resource attribute of the monitored application entity changes.

18.-19. (canceled)
